(19) United States
(12) Patent Application Publication
(10) Pub. No.: US 2026/0366646 A1
(43) Pub. Date: Nov. 19, 2026

(54) PRESSURE VACUUM RELIEF VALVE POSITION MONITORING WITH VOLUMETRIC MEASUREMENT

(71) Applicant: Emerson Automation Solutions Final Control US LP, Houston, TX (US)

(72) Inventors: Adam Randolph Attig, Houston, TX (US); Ricardo Jose Garcia, Stafford, TX (US); Derek Thomas Kelly, Tulsa, OK (US); Carlos Antonio Matos, Old River Winfree, TX (US)

(21) Appl. No.: 19/677,136

(22) Filed: May 14, 2026

Related U.S. Application Data
(60) Provisional application No. 63/805,599, filed on May 14, 2025.

(51) Int. Cl. F16K 37/00; F17C 13/02

(52) U.S. Cl. CPC F16K 37/0091; F17C 13/02; F17C 2205/0332

(57) ABSTRACT

Systems, apparatus, articles of manufacture, and methods are disclosed for pressure vacuum relief valve position monitoring with volumetric measurement. An example system includes a radar sensor to emit a radio wave; a valve, the radar sensor to detect reflection of the radio wave on a surface of the valve; machine-readable instructions; and at least one programmable circuit to execute the machine-readable instructions to determine, based on an output of the radar sensor associated with reflection of the radio wave, that the valve is in an open state; responsive to the valve being in the open state, determine an amount of fluid discharged via the valve; and output a notification indicative of the amount of discharged fluid.

### RELATED APPLICATION

This patent claims the benefit of U.S. Provisional Patent Application No. 63/805,599, which was filed on May 14, 2025. U.S. Provisional Patent Application No. 63/805,599 is hereby incorporated herein by reference in its entirety. Priority to U.S. Provisional Patent Application No. 63/805,599 is hereby claimed.

### FIELD OF THE DISCLOSURE

This disclosure relates generally to pressure relief valves and, more particularly, to pressure vacuum relief valve position monitoring with volumetric measurement.

### BACKGROUND

Pressure vacuum relief valves (PVRVs) provide protection against positive or vacuum overpressure. PVRVs also prevent air intake and evaporative losses of product while helping to contain odorous and potentially explosive vapors.

### BRIEF DESCRIPTION OF THE DRAWINGS

FIG. 1 is an example system including a pressure vacuum relief valve, a radar sensor, and analysis circuitry in accordance with teachings of this disclosure.

FIG. 2 is a block diagram of an example implementation of the analysis circuitry of FIG. 1.

FIG. 3 is a flowchart representative of example machine-readable instructions and/or example operations that may be executed, instantiated, and/or performed by example programmable circuitry to implement the analysis circuitry of FIG. 2.

FIG. 4 is a block diagram of an example processing platform including programmable circuitry structured to execute, instantiate, and/or perform the example machine-readable instructions and/or perform the example operations of FIG. 3 to implement the analysis circuitry of FIG. 2.

In general, the same reference numbers will be used throughout the drawing(s) and accompanying written description to refer to the same or like parts. The figures are not necessarily to scale.

### DETAILED DESCRIPTION

Examples disclosed herein use a radar sensor (e.g., a radar level transmitter) to measure the lift or position of a moveable surface within a valve, such as a pallet of a pressure vacuum relief valve (PVRV). Based on lift value(s) (e.g., lift percentage) associated with the movable surface within the valve, disclosed examples determine (e.g., calculate) the volume of process fluid flowing from an enclosed space (e.g., a tank) through the valve when the valve is in an open state.

In examples disclosed herein, a radar sensor transmits radio waves (e.g., pulses) in the direction of a surface of the pallet, and the radio waves are reflected by the surface and detected by a receiver of the radar sensor. The strength of the reflected waves detected by the receiver of the radar sensor and/or the time for the reflected waves to be detected by the receiver (e.g., time-of-flight) can be used to identify changes in valve state over time (e.g., movement from a closed state to an open state). The use of non-contact radar sensors enables pallet lifting to be monitored without interfering with movement of the pallet.

In some examples, in response to determining that a valve has moved to an open state (e.g., based on pallet lift position) and, thus, fluid is being discharged, the disclosed examples communicate with one or more devices in the environment (e.g., a process control system) to cause the device(s) to take action(s). For example, disclosed examples can cause a pump or blower to activate to facilitate removal of the discharged fluid from the environment.

Examples disclosed herein provide for troubleshooting and/or system diagnostics. For example, redundant PVRVs are often used for added safety. If a primary valve fails to close or partially closes, then a backup valve can address pressure events to protect a tank to which the valves are coupled. However, because the primary valve is not operating as expected, the benefits of redundancy and additional safety provided by having two valves are lost and should be addressed. Examples disclosed herein can monitor the state of the backup valve based on changes in the radar sensor data (e.g., reflected wave strength, time-of-flight). If the backup valve moves to the open state, examples disclosed herein can be used to assess whether the primary valve is functioning as expected or whether a pressure control issue in the enclosed space that is causing both valves to open. Thus, examples disclosed herein can be used to detect process volume loss as well as a state of error that may need to be addressed.

In examples disclosed herein, the determination of the volume of emitted fluid in connection with pressure relief events facilitates compliance with various regulations, including regulations for tank valve emissions. The detected volume of process fluid can also be used to calculate product loss and associated costs. In some examples, the detected volume of emitted process fluid can be used to assess the quality of product with respect to atmospheric contamination.

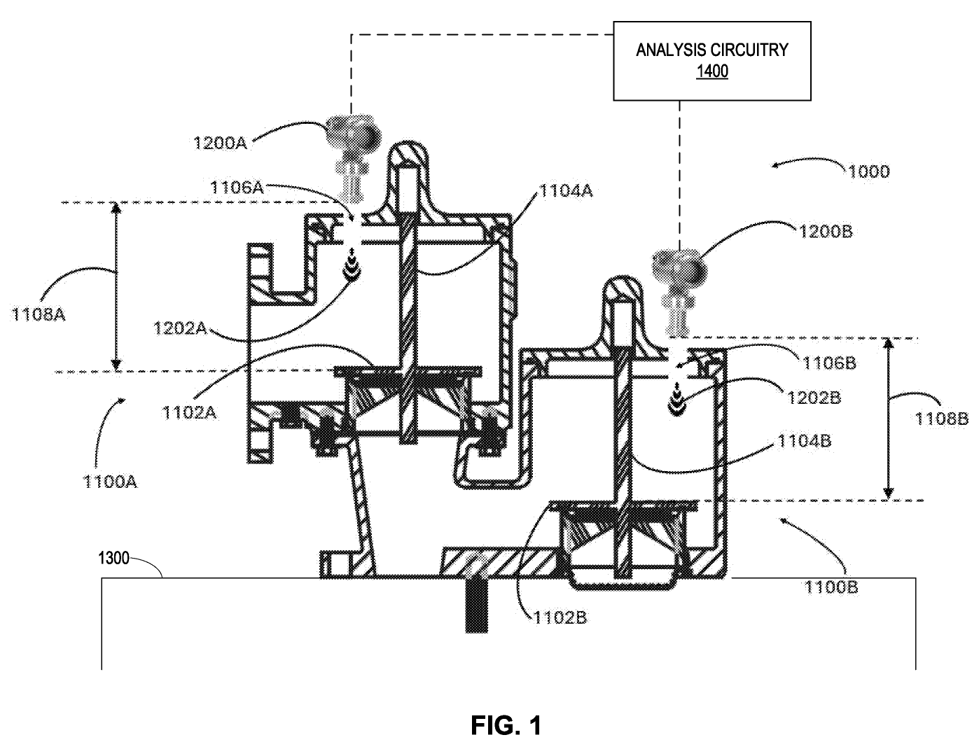

FIG. 1 is an example system 1000 including a first valve 1100A and a second valve 1100B (where the valves 1100A, 1100B are shown in a cross-sectional view). The first and second valves 1100A, 1100B include respective first and second pallets 1102A and 1102B, respective first and second stems 1104A and 1104B, and respective first and second connection ports 1106A and 1106B. The valves 1100A, 1100B are coupled to a tank 1300. In some examples, the example system 1000 only includes one valve (e.g., the second valve 1100B is not present). In some examples, the example system 1000 includes multiple valves (e.g., two or more). In examples including multiple valves, the valves may be the same type of valve or different from one another.

In the example of FIG. 1, the first and second valves 1100A, 1100B are pressure vacuum relief valves (PVRVs). Other kinds of valves may be used alone or in conjunction with the valves 1100A, 1100B for the system 1000. In some examples, the valves 1100A, 1100B are configured to enable relief events. Relief events include over pressure due to positive pressure or under pressure due to vacuum pressure that have been determined to be excessive for the system 1000. For example, in the orientation of the tank 1300 of FIG. 1, the valves 1100A, 1100B are coupled to (e.g., affixed to) a top surface of the tank 1300. Each valve 1100A, 1100B may (a) open temporarily to release fluid to the atmosphere when the pressure below the valve 1100A, 1100B satisfies or exceeds a threshold (where the threshold is indicative of an undesirable pressure level), and (b) close once the pressure has fallen below the threshold (e.g., returns to a desired pressure level).

In the example of FIG. 1, each valve 1100A, 1100B maintains a seal until system pressure or vacuum exceeds a set pressure of the respective valve 1100A, 1100B. In some examples, the pressure and vacuum set points are defined as minimum settings. In some examples, the set pressure for each valve 1100A, 1100B is determined by stacking a series of weights onto the corresponding pallet 1102A, 1102B. When overpressure occurs, the weighted pallet 1102A, 1102B of the respective valve 1100A, 1100B lifts, breaking a seal between the respective pallet 1102A, 1102B and a corresponding surface. As a result, vapors pass through the orifice of corresponding valve 1100A, 1100B and relieve pressure buildup. The valves 1100A, 1100B reseal upon relief.

The redundant valves 1100A, 1100B provide for additional safety in the system 1000. For example, if the primary valve (e.g., the first valve 1100A) fails to close or partially closes, then the backup valve (e.g., the second valve 1100B) can provide for pressure relief. In some examples, a pressure set point for the backup valve is higher than the pressure set point for the primary valve. As such, if the primary valve fails, the enclosed space (e.g., the tank 1300) remains protected.

The example system 1000 of FIG. 1 includes a first radar sensor 1200A (e.g., a radar level transmitter) and a second radar sensor 1200B (e.g., a radar level transmitter). The first radar sensor 1200A is associated with the first valve 1100A and the second radar sensor 1200B is associated with the second valve 1100B. A first distance 1108A between the first radar sensor 1200A (e.g., a receiver of the first radar sensor 1200A) and a surface of the first pallet 1102A (e.g., a top surface of the first pallet 1102A in the orientation of FIG. 1) will change as the first pallet 1102A lifts and moves along the first stem 1104A during an over- or under-pressure relief event. Similarly, a second distance 1108B between the second radar sensor 1200B (e.g., a receiver of the second radar sensor 1200B) and a surface of the second pallet 1102B (e.g., the top surface of the second pallet 1102B in the orientation of FIG. 1) will change as the second pallet 1102B lifts and moves along the second stem 1104B during an over- or under- pressure relief event. Thus, in the example of FIG. 1, radar sensing is used to monitor the position of the pallets 1102A, 1102B of each valve 1100A, 1100B and, thus, the state of the valves 1100A, 1100B (e.g., open state, closed state). However, in other examples, only one of the valves 1100A, 1100B may include a radar sensor.

The first radar sensor 1200A includes a transmitter that emits radio waves 1202A (e.g., electromagnetic wave pulses) with a predefined frequency in the direction of the first pallet 1102A and a receiver that receives at least some of those radio waves 1202A reflected off a surface (e.g., the top surface) of the first pallet 1102A. The second radar sensor 1200B includes a transmitter that emits radio waves 1202B (e.g., electromagnetic wave pulses) with a predefined frequency in the direction of the second pallet 1102B and a receiver that receives at least some of those radio waves 1202B reflected off a surface (e.g., the top surface) of the second pallet 1102B. The transmitter of the respective radar sensors 1200A, 1200B can emit the radio waves 1202A, 1202B at periodic intervals (e.g., every 30 seconds, every minute). The receiver of each radar sensor 1200A, 1200B can measure, for example, the strength of the return or reflected radio waves 1202A, 1202B or a time for the radio waves 1202A, 1202B to be reflected back to the receiver (i.e., time-of-flight). In some examples, the receiver and the transmitter associated with each radar sensor 1200A, 1200B are co-located within the same device and, in such examples, may share the same antenna for both transmission and reception. In other examples, the receiver and transmitter of one or more of the radar sensors 1200A, 1200B are located in separate devices.

In the example of FIG. 1, the radar sensors 1200A, 1200B are non-contacting sensors. The non-contacting radar technology implemented by the sensors 1200A, 1200B enables a top-down installation at the tank 1300 (e.g., installation at the top of the tank 1300 in the orientation shown in FIG. 1) that reduces the risk of leakages. Further, the non-contact radar sensors 1200A, 1200B are not affected or not substantially affected by process conditions such as density, viscosity, temperature, pressure, and pH. For example, the radar sensors 1200A, 1200B can be used with process applications including a broad range of liquids, slurries, and solids. The radar sensors 1200A, 1200B can be certified for use in hazardous locations and meet NAMUR (User Association of Automation Technology in Process Industries) recommendations.

The locations of the first and second radar sensors 1200A, 1200B relative to the first and second valves 1100A, 1100B can be based on, for example, conditions of the enclosure (e.g., the tank 1300) that includes the valves 1100A, 1100B. For example, the radar sensors 1200A, 1200B can be installed at locations with an unobstructed or substantially unobstructed view of the corresponding movable surfaces (e.g., the respective pallets 1102A, 1102B). The obstructions (e.g., number of obstructions) within the emission path of the radar beam of the radio waves 1202A, 1202B can be considered and minimized during installation of the radar sensors 1200A, 1200B (e.g., in view of consideration of other system and process constraints).

In some examples, the radar sensors 1200A, 1200B are two-wire, non-contacting radar sensors. In some examples, the radar sensors 1200A, 1200B use Frequency Modulated Continuous Wave (FMCW) technology to increase (e.g., maximize) measurement accuracy and reliability, particularly when the system 1000 is used in environments such as small tanks and fast-filling vessels. In some examples, the radar sensors 1200A, 1200B include programmable circuitry (e.g., processor circuitry) that executes algorithm(s) to facilitate (e.g., increase) measurement accuracy.

In some examples, the radar sensors 1200A, 1200B use a two-wire, 4-20mA protocol, such as 4-20 mA Highway Addressable Remote Transducer (HART^{®}). For 4-20 mA HART^{®}, a digital process variable is superimposed on a 4-20 mA signal, and is available to a host that conforms to the HART^{®} protocol. The digital HART^{®} signal can be used in multidrop mode.

In some examples, a 4mA current loop signal may be used when the valve(s) 1100A, 1100B are closed, and a 20mA current loop signal may be used when the valve(s) 1100A, 1100B are open and then linearly scaled (e.g., scaled up). Alternatively, a 4mA current loop signal may be used when the valve(s) 1100A, 1100B are open, and a 20mA current loop signal may be used when the valve(s) 1100A, 1100B are closed. Other process control signal schemes may be used as well.

In some examples, for an analog signal alarm, the radar sensors 1200A, 1200B can perform (e.g., automatically perform, continuously or substantially continuously perform) self-diagnostic routines. If a failure or a measurement error is detected, the analog signal can be driven off scale to alert a user. The radar sensor failure modes can be user-configured. For example, a high failure mode signal can be defined as greater than or equal to 21.75 mA and a low failure mode signal can be defined as less than or equal to 3.75 mA.

In some examples, to address analog saturation levels, the radar sensors 1200A, 1200B can set a current that corresponds to a measurement value until reaching an associated saturation limit (and then freeze). For example, a high saturation limit can be defined as 20.8 mA, and a low saturation limit can be defined as 3.9 mA.

In some examples, the radar sensors 1200A, 1200B can use a scaled variable configuration to convert a device variable into an alternative measurement, such as flow, mass, or calibrated level (e.g., five-point verification).

In some examples, a level test is performed to test the behavior of the respective radar sensors 1200A, 1200B in a tank environment. During the test, a virtual surface echo is superimposed onto a radar signal emitted by the respective radar sensor 1200A, 1200B, and the radar sensor 1200A, 1200B outputs a level corresponding to the echo position. The test verifies the integrity of the signal processing and can be used to test the alarm limits in the host system, the outputs of radar sensor(s) 1200A, 1200B, and/or configuration of the radar sensor(s) 1200A, 1200B (e.g., the upper/lower range values, such as analog signal or signal saturation levels).

In some examples, the respective radar sensors 1200A, 1200B include a diagnostic tool (e.g., an automatic diagnostic tool) that monitors performance and integrity of the radar sensor 1200A, 1200B without interrupting sensor processes. The diagnostic tool can output a report (e.g., a pass/fail summary report) and transmit the report to, for example, a user device (e.g., via wired or wireless communication protocols) to facilitate identification and resolution of potential issues with the radar sensor(s) 1200A, 1200B. In some examples, the diagnostic tool can track (e.g., record) sensor configuration changes since a previous verification to verify consistency with respect to the respective radar sensors 1200A, 1200B and, thus, the system 1000. The diagnostic tool can be scheduled to run at defined intervals or initiated on demand.

The example system 1000 can include additional devices than shown in FIG. 1. In some examples, a signal converter is used to convert a digital HART^{®} multivariable signal into three independent 4-20 mA analog process variables without additional transmitters and wiring. For example, the three additional 4–20 mA analog signals can be generated by sending the digital HART^{®} signal to the optional signal converter. In some examples, a wireless adapter can be coupled to one or more of the radar sensors 1200A, 1200B (e.g., mounted directly on the radar sensor(s) 1200A, 1200B or by using a remote mounting kit). For example, wireless sensor networking technology, such as WirelessHART^{®}, can enable multivariable data and diagnostics and add wireless capability to a measurement point.

The example system 1000 of FIG. 1 includes analysis circuitry 1400 (e.g., programmable circuitry) to analyze outputs of the respective radar sensors 1200A, 1200B and to determine an amount (e.g., volume) of fluid (e.g., process fluid) flowing through the valve(s) 1100A, 1100B in examples in which the valve(s) 1100A, 1100B open due to a pressure event. The analysis circuitry 1400 is in communication with the radar sensors 1200A, 1200B via one or more communication protocols (e.g., wireless communication protocols, wired communication protocols). In some examples, the analysis circuitry 1400 is implemented by programmable circuitry of a respective radar sensor 1200A, 1200B. In some examples, the analysis circuitry 1400 is implemented by programmable circuitry of one of the radar sensors 1200A, 1200B. In such examples, measurements collected by the other one of the radar sensors 1200A, 1200B are transmitted (e.g., wirelessly transmitted) to the one of the radar sensors 1200A, 1200B that implements the analysis circuitry 1400. In some examples, the radar sensor(s) 1200A, 1200B include a display to present, for example, measurements collected by the radar sensor(s) 1200A, 1200B and/or data generated by the analysis circuitry 1400.

In some examples, the analysis circuitry 1400 is implemented by one or more electronic devices such as a field device, a process control device (e.g., a regulator), and/or an electronic user device (e.g., an electronic tablet). In some examples, the radar sensor(s) 1200A, 1200B and/or the analysis circuitry 1400 communicates with an electronic device to cause the electronic device to output data for display. For example, outputs (e.g., measurements) by the radar sensor(s) 1200A, 1200B and/or data (e.g., notification(s)) generated by the analysis circuitry 1400 can be transmitted to a device such as a field signal indicator for presentation. In some examples, the radar sensor(s) 1200A, 1200B provide for Bluetooth^{®} connectivity (e.g., Bluetooth Low Energy (BLE)).

In some examples, one or more components of the analysis circuitry 1400 are implemented by the radar sensor(s) 1200A, 1200B and/or electronic device(s) and one or more other components of the analysis circuitry 1400 are implemented by one or more cloud-based devices (e.g., one or more server(s), processor(s), and/or virtual machine(s)). In some examples, the analysis circuitry 1400 is implemented by cloud-based devices and the radar sensors 1200A, 1200B transmit data to the cloud-based analysis circuitry 1400 via wireless communication protocols.

In some examples, the analysis circuitry 1400 monitors data from radar sensors associated with multiple tanks, such as the tank 1300 and one or more other tanks in an environment in which the tank 1300 is located. In some examples, the analysis circuitry 1400 monitors data for valves associated with the tank 1300 and valves associated with other types of equipment in the environment.

The example analysis circuitry 1400 of FIG. 1 analyzes the outputs of the first and second radar sensors 1200A, 1200B with respect to the radio waves 1202A, 1202B reflected back by the surface of the corresponding pallet 1102A, 1102B to determine one or more properties of the corresponding valves 1100A, 1100B with which the respective radar sensors 1200A, 1200B are associated. Based on the outputs of the radar sensors 1200A, 1200B that characterize the reflected signals (e.g., signal strength, time-of-flight), the analysis circuitry 1400 monitors movement of the pallet(s) 1102A, 1102B along the corresponding stem(s) 1104A, 1104B and determines an amount (e.g., volume) of fluid emitted due to the opening of the valve(s) 1100A, 1100B in connection with the relief event. For example, the analysis circuitry 1400 can determine the respective distances 1108A, 1108B between the wave reflecting surface of the pallets 1102A, 1102B and the corresponding radar sensors 1200A, 1200B (e.g., the receiver of each radar sensor 1200A, 1200B) over time and identify changes in the distance(s) 1108A, 1108B that are indicative of the valve(s) 1100A, 1100B moving from a closed state to an open state. In some examples, based on the outputs of the radar sensor(s) 1200A, 1200B, the analysis circuitry 1400 can determine a shape of the corresponding valve(s) 1100A, 1100B and/or an orientation of the wave reflecting surface(s) of the pallet(s) 1102A, 1102B.

The analysis circuitry 1400 uses the characteristics or the properties associated with the reflected radio waves 1202A, 1202B (e.g., signal strength, time-of-flight) to determine an amount of lift (e.g. lift percentage, distance traveled) associated with the respective pallets 1102A, 1102B. Based on the amount of lift, the analysis circuitry 1400 calculates the volume of process fluid flowing through the respective valves 1100A, 1100B due to the opening of valves 1100A, 1100B. As disclosed herein, the analysis circuitry 1400 uses reference flow curves associated with the respective valves 1100A, 1100B to determine the volume of emitted fluid for corresponding positions of the pallets 1102A, 1102B.

In examples in which the analysis circuitry 1400 determines that process fluid has been emitted due to opening of the valve(s) 1100A, 1100B, the analysis circuitry 1400 can cause one or more actions. For example, the analysis circuitry 1400 can cause notification(s) to be output for presentation via display screen(s) of user device(s), display screen(s) of the radar sensor(s) 1202A, 1202B, and/or display screen(s) of field device(s) (e.g., a field signal indicator). The notification(s) can provide guidance with respect to troubleshooting within the system 1000 and/or system diagnostics. In some examples, the valve(s) 1100A, 1100B are associated with a manifold through which vapors flow. If the analysis circuitry 1400 determines that the one or more of the valves 1100A, 1100B have opened, the analysis circuitry 1400 can output notification(s) to inform a user that because the valve(s) 1100A, 1100B are open, the flow path of the vapors through the manifold is disrupted.

In some examples, the analysis circuitry 1400 outputs instructions to control operation of one or more process control devices in response to determining that the valve(s) 1100A, 1100B have opened. In some examples, the analysis circuitry 1400 communicates with one or more process control devices to cause, for example, a blower or pump in the environment in which the tank 1300 is located to activate to remove the discharged process fluid. For example, an exhaust hose can be coupled to a respective valve 1100B, 1100A to direct the emitted process fluid away from the environment in which the tank 1300 is located. In response to determining that one or more of the valves 1100A, 1100B have opened and process fluid has been released, the analysis circuitry 1400 can cause a pump or blower to activate to facilitate removal of the process fluid via the exhaust hose.

In some examples, tank blanketing is implemented at the tank 1300 such that an inert gas (e.g., nitrogen) is inserted into the vapor space in the tank 1300. A blanketing regulator controls the flow of nitrogen or other blanketing gas in the vapor space of the tank 1300 by responding to a low pressure set point. In such examples, the valves 1100A, 1100B serve as a backup to the blanketing regulator and are closed during expected (e.g., normal) operation of the blanketing regulator. If the blanketing system fails, the valve(s) 1100A, 1100B open (e.g., because the pressure set point of the respective valves 1100A, 1100B can be set higher than the pressure set point of the blanketing regulator). Based on the outputs of the radar sensor(s) 1200A, 1200B that are indicative of changes in one or more of the distances 1108A, 1108B between the pallets 1102A, 1102B and corresponding radar sensor 1200A, 1200B, the analysis circuitry 1400 recognizes that the valve(s) 1100A, 1100B have opened and, thus, the blanketing gas (e.g., nitrogen) is being emitted. The analysis circuitry 1400 can cause notification(s) to be output identifying that the valve(s) 1100A, 1100B have opened (e.g., due to failure of the blanketing regulator). In some examples, the analysis circuitry 1400 can cause a pump in the environment in which the tank 1300 is located to be activated to remove the nitrogen or other blanketing gas from the environment via the pump.

In some examples, the tank 1300 includes an emergency vent which is closed during expected (e.g., normal) operation and opens to release excess pressure. In some examples, the analysis circuitry 1400 receives data indicative of a state of the emergency vent from, for example, sensor(s) associated with the emergency vent. If the analysis circuitry 1400 determines that (a) the emergency vent has opened (e.g., based on output(s) of the sensor(s) associated with the vent) and (b) the valve(s) 1100A, 1100B are in a closed state (e.g., based on output(s) of the radar sensor(s) 1200A, 1200B indicating that the distance(s) 1108A, 1108B have not changed over time), then the analysis circuitry 1400 determines that a pressure control issue may be present in the system 1000 and/or maintenance of the valve(s) 1100A, 1100B is warranted. The analysis circuitry 1400 can output notification(s) indicative of such events to facilitate system diagnostics.

Although the example of FIG. 1 is primarily discussed in connection with the weighted valves 1100A, 1100B (e.g., the PVRVs 1100A, 1100B), examples disclosed herein can be used with other types of valves such as spring-loaded PVRVs and/or overpressure protection PVRVs. Also, although examples disclosed herein are discussed in connection with the radar sensors 1200A, 1200B, other types of level detection means can be used, such as laser sensors. Further, although examples disclosed herein are primarily discussed in connection with measuring emissions due to the opening of the valves 1100A, 1100B, examples disclosed herein can use radio waves to measure properties of lids, diaphragms, stems, discs, and/or surfaces of other components of the valves 1100A, 1100B. Also, although the example system 1000 of FIG. 1 is discussed in connection with the tank 1300, the example system 1000 of FIG. 1 can be used in a broad range of applications. For example, the system 1000 of FIG. 1 (e.g., the radar sensors 1200A, 1200B) can be used in tanks and/or vessels with small process fittings, in corrosive environments, and/or with open-air installations.

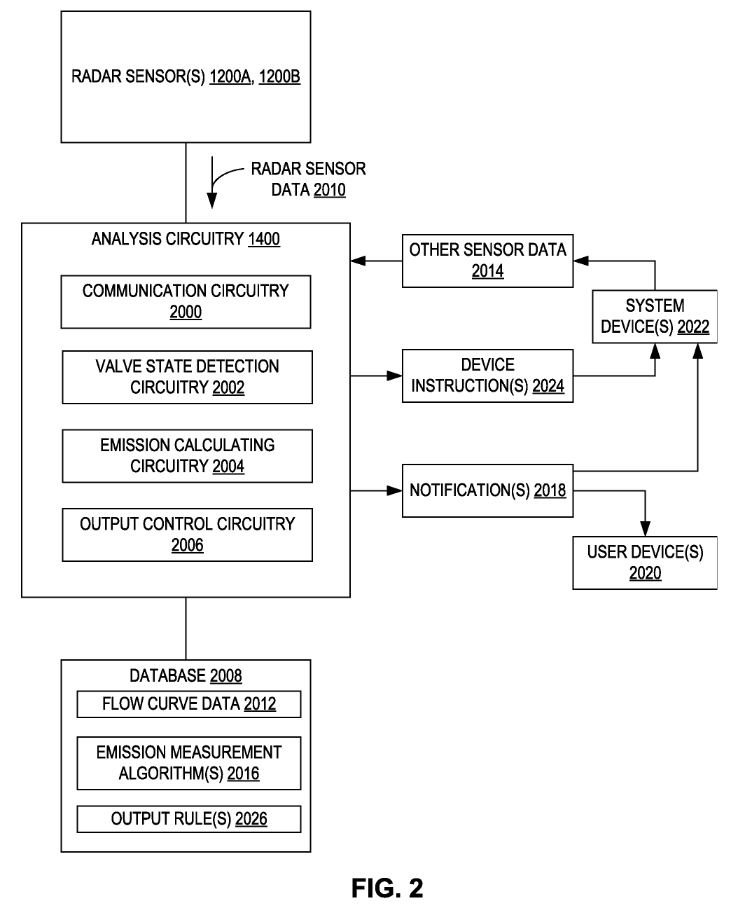

FIG. 2 is a block diagram of an example implementation of the analysis circuitry 1400 of FIG. 1 to identify a respective state (e.g., an open state, a closed state) of the valves 1100A, 1100B associated with the tank 1300 of FIG. 1 and determine volumetric emission of process fluid when the valve(s) 1100A, 1100B are in an open state. The analysis circuitry 1400 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the analysis circuitry 1400 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or

FPGA circuitry performing operations to implement one or more virtual machines and/or containers.

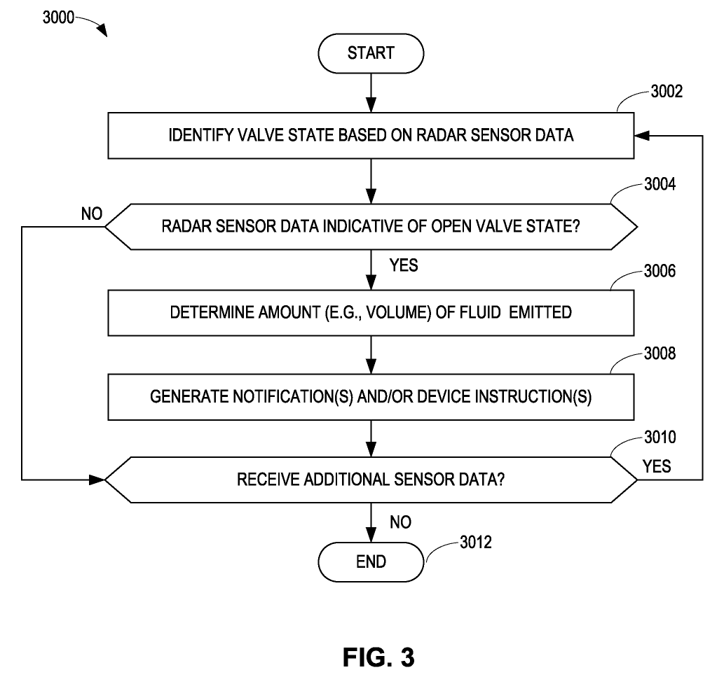

The example analysis circuitry 1400 of FIG. 2 includes communication circuitry 2000, valve state detection circuitry 2002, emission calculating circuitry 2004, and output control circuitry 2006. The example analysis circuitry 1400 is in communication with a database 2008. In some examples, the communication circuitry 2000 is instantiated by programmable circuitry executing communication instructions and/or configured to perform operations such as those represented by the flowchart of FIG. 3. In some examples, the valve state detection circuitry 2002 is instantiated by programmable circuitry executing valve state detection instructions and/or configured to perform operations such as those represented by the flowchart of FIG. 3. In some examples, the emission calculating circuitry 2004 is instantiated by programmable circuitry executing emission calculating instructions and/or configured to perform operations such as those represented by the flowchart of FIG. 3. In some examples, the output control circuitry 2006 is instantiated by programmable circuitry executing output control instructions and/or configured to perform operations such as those represented by the flowchart of FIG. 3.

The communication circuitry 2000 of the example analysis circuitry 1400 of FIG. 2 accesses, receives, or otherwise obtains sensor data 2010 from the radar sensors 1200A, 1200B. The sensor data 2010 can indicate strength of the radio waves 1202A, 1202B reflected by the surface of the pallet(s) 1102A, 1102B and/or the time-of-flight with respect to a time for the radio waves 1202A, 1202B reflected by the pallet surface to be detected by the radar sensor(s) 1200A, 1200B. The sensor data 2010 can be stored in the database 2008.

In some examples, the communication circuitry 2000 transmits instructions to the radar sensor(s) 1200A, 1200B. For example, the communication circuitry 2000 can generate and output instructions to cause the radar sensor(s) 1200A, 1200B to emit the radio waves 1202A, 1202B (e.g., pulses) at particular time intervals (e.g., as defined based on user settings).

Based on the radar sensor data 2010 (e.g., reflected wave signal strength, time-of-flight), the valve state detection circuitry 2002 determines lift values associated with the respective distances 1108A, 1108B between the surface of the pallets 1102A, 1102B and the corresponding radar sensors 1200A, 1200B. The lift values can be defined as a function of amount (e.g., distance traveled) or lift percentage. The valve state detection circuitry 2002 analyzes the lift of the pallets 1102A, 1102B over time to identify the valve state (e.g., open state, closed state). For example, in response to determining that the distance 1108A between the surface of the first pallet 1102A and the first radar sensor 1200A has decreased over time (e.g., due to lift of the first pallet 1102A), the valve detection circuitry 2002 can determine that the first valve 1100A has moved from a closed state to an open state. Put another way, the valve state detection circuitry 2002 can detect relief event(s) at the valve(s) 1100A, 1100B using the radar sensor data 2010.

In examples in which the valve state detection circuitry 2002 determines that the valve(s) 1100A, 1100B moved to an open state, the emission calculating circuitry 2004 determines a volumetric release of fluid (e.g., process fluid) due to the opening of the valve(s) 1100A, 1100B. For example, the emission calculating circuitry 2004 can determine the discharged fluid volume for a given amount of pallet lift at each valve 1100A, 1100B (as determined based on the changes in the corresponding distances 1108A, 1100B). In some examples, the emission calculating circuitry 2004 determines the volume of emitted fluid over a period of time as a function of how long the valve(s) 1100A, 1100B remained open at the corresponding lift level(s). In some examples, the emission calculating circuitry 2004 determines the amount of fluid emitted based on a total flow through the first and second valves 1100A, 1100B.

In the example of FIG. 2, the emission calculating circuitry 2004 uses flow curve data 2012 to determine the volume of the emitted fluid. The flow curve data 2012 is stored in the database 2008. Different types of valves and/or sizes of valves have different flow curves associated with them, which may be specified by a manufacturer of a valve and/or learned through a characterization process using properties of the environment in which the valve is intended for operation. For example, a flow curve specifies different flow rate values associated with different percentages of pallet lift and/or distance traveled. In some examples, the flow curves are a function of other factors, such as the type of fluid stored in a tank to which the valve is to be coupled, external air pressure, and/or temperature.

The flow curve data 2012 of FIG. 2 includes flow curves for the valves 1100A, 1100B of the system 1000 of FIG. 1 (e.g., where the flow curve data is stored in tables). In some examples, the external air pressure and/or the temperature can be measured by sensors in the environment including the tank 1300 and the outputs of those sensors can be received by the communication circuitry 2000 as other sensor data 2014. In some such examples, the emission calculating circuitry 2004 can use the other sensor data 2014 to determine or adjust the flow curve data 2012 in view of conditions in the environment including the tank 1300.

The emission calculating circuitry 2004 executes one or more emission measurement algorithms 2016 using the flow curve data 2012 to determine an amount (e.g., volume) of flow through the valve(s) 1100A, 1100B given the amount of lift associated with the corresponding pallet(s) 1102A, 1102B. For example, the emission calculating circuitry 2004 uses the flow curve data 2012 and the lift values (e.g., distance traveled, lift percentage) determined from the radar sensor data 2010 to identify the flow rate for specific relief event(s). Based on the flow rate, the emission calculating circuitry 2004 determines the volume of fluid emitted (e.g., over time or for a given lift value). The emission measurement algorithm(s) 2016 can define variables and relationships between the variables for determining the amount (e.g., volume) of emitted fluid, such as flow rate, lift values, the duration of time the valve(s) 1100A, 1100B were open, etc. The emission measurement algorithm(s) 2016 are stored in the database 2008.

In some examples, the emission calculating circuitry 2000 determines a total volume of fluid emission for a relief event by summing the volume calculated for each of a plurality of observation intervals in which the lift was measured using the corresponding radar sensor data 2010 for those intervals. The emission calculating circuitry 2000 can calculate the volume of fluid emission during a relief event in other ways, such as a function of how high the pallet(s) 1102A, 1102B rose, how long the valve(s) 1100A, 1100B remained open at the lift level, and/or a rate at which the pallet(s) 1102A, 1102B rose (e.g., during opening of the valve(s) 1100A, 1100B) or fell (e.g., during resealing).

In some examples, the emission calculating circuitry 2004 stores the fluid emission amounts over time (e.g., month, year, etc.) in the database 2008 for reporting and/or compliance purposes. In some examples, the emission calculating circuitry 2000 outputs the fluid emission data to, for example, a central gateway device associated with a process control system that includes the system 1000 of FIG. 1.

In some examples, the emission calculating circuitry 2004 determines the fluid emission amount in connection with opening of the valve(s) 1100A, 1100B based on other properties determined from the radar sensor data 2010 in addition to or an alternative to using the lift distance. For example, the radar sensor data 2010 can be indicative of valve shape and/or pallet orientation (e.g., based on reflection of the radio waves 1202A, 1202B by different portions of a respective pallet 1102A, 1102B as measured by the corresponding radar sensor 1200A, 1200B as part of a radar scanning process). In such examples, the emission calculating circuitry 2004 can map different radar scan results to different flow volumes. In some examples, the emission calculating circuitry 2004 can execute one or more machine learning models (e.g., the emission measurement algorithm(s) 2016) to map the orientation of the pallet(s) 1102A, 1102B to fluid emission volumes. In such examples, the machine learning model(s) are trained to associate pallet orientation with valve opening states and corresponding fluid emission volumes.

The output control circuitry 2006 generates and outputs notification(s) 2018 indicative of, for example, a state of the valve(s) 1100A, 1100B (e.g., an open state); the amount (e.g., volume) of fluid (e.g., process fluid) emitted via the valve(s) 1100A, 1100B; the pallet lift percentage; a length of time the valve(s) 1100A, 1100B have been open, etc. In some examples, the output control circuitry 2006 generates and outputs the notification(s) 2018 when a pressure relief event (e.g., valve opening) is detected but not otherwise. In some examples, the output control circuitry 2006 generates and outputs the notification(s) 2018 regardless of detection of a pressure relief event. The notification(s) 2018 can include audio notification(s) output via, for example, audio device(s) associated with the system 1000 of FIG. 1 to alert a user of the relief event and/or to serve as an indication that maintenance should be performed. The notification(s) 2018 can include visual notification(s) output via one or more user device(s) 2020 and/or system device(s) 2022 (e.g., field device(s), the radar sensor(s) 1200A, 1200B, process control device(s)). For example, the notification(s) 2018 can be output for display via the device(s) 2020, 2022 to inform user(s) of the amount of process fluid emitted over time (e.g., as an indication of product loss). In some examples, the notification(s) 2018 are indicative of flow through each of the valves 1100A, 1100B. In some examples, the notification(s) 2018 are indicative of combined fluid emitted through the first and second valves 1100A, 1100B.

In some examples, the type(s) of notification(s) 2018 are based on the volumetric measurement of fluid emitted. For example, if the fluid discharged from the tank exceeds a threshold value, the output control circuitry 2006 can cause both audio and visual notification(s) 2018 to be output, can escalate the frequency of the transmission of notification(s) 2018, etc.

In some examples, the output control circuitry 2006 generates device instruction(s) 2024 to cause one or more of the system device(s) 2020 to take action(s) (e.g., turn on, change operating mode). For example, in response to determining that the valve(s) 1100A, 1100B have moved from a closed state to an open state, the output control circuitry 2006 can generate and output device instruction(s) to cause a pump to be activated to facilitate removal of the discharged process fluid from the environment. In the example of FIG. 3, the output control circuitry 2006 generates the notification(s) 2018 and/or device instruction(s) 2024 based on output rule(s) 2026 stored in the database 2008. The output rule(s) 2026 define the type(s) of notification(s) 2018 and/or device instruction(s) 2024 in view of valve state, lift amount, volume of emitted fluid, etc. The output rule(s) 2026 can be defined based on user inputs.

While an example manner of implementing the analysis circuitry 1400 of FIG. 1 is illustrated in FIG. 2, one or more of the elements, processes, and/or devices illustrated in FIG. 2 may be combined, divided, re-arranged, omitted, eliminated, and/or implemented in any other way. Further, the example communication circuitry 2000, the example valve state detection circuitry 2002, the example emission calculating circuitry 2004, the example output control circuitry 2006 and/or, more generally, the example analysis circuitry 1400 of FIG. 2, may be implemented by hardware alone or by hardware in combination with software and/or firmware. Thus, for example, any of the example communication circuitry 2000, the example valve state detection circuitry 2002, the example emission calculating circuitry 2004, the example output control circuitry 2006, and/or, more generally, the example analysis circuitry 1400, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example analysis circuitry 1400 of FIG. 2 may include one or more elements, processes, and/or devices in addition to, or instead of, those illustrated in FIG. 2, and/or may include more than one of any or all of the illustrated elements, processes and devices.

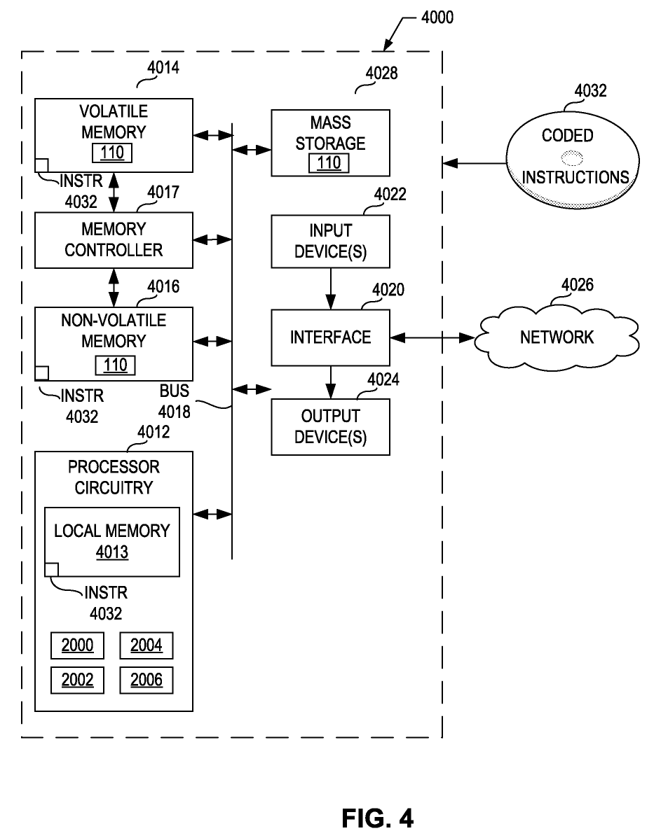

A flowchart representative of example machine-readable instructions, which may be executed by programmable circuitry to implement and/or instantiate the analysis circuitry 1400 of FIG. 2 and/or representative of example operations which may be performed by programmable circuitry to implement and/or instantiate the analysis circuitry 1400 of FIG. 2, is shown in FIG. 3. The machine-readable instructions may be one or more executable programs or portion(s) of one or more executable programs for execution by programmable circuitry such as the programmable circuitry 4012 shown in the example processor platform 4000 discussed below in connection with FIG. 4 and/or may be one or more function(s) or portion(s) of functions to be performed by example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIG. 3, many other methods of implementing the example analysis circuitry 1400 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 3 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/ or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 3 is a flowchart representative of example machine-readable instructions and/or example operations 3000 that may be executed, instantiated, and/or performed by programmable circuitry to determine an amount of fluid emitted in response to a valve event (e.g., a pressure relief event). The example machine-readable instructions and/or the example operations 3000 of FIG. 3 begin at block 3002, at which the valve state detection circuitry 2002 of FIG. 2 determines a state (e.g., an open state, a closed state) of the valves 1100A, 1100B of the system 1000 of FIG. 1 based on the radar sensor data 2010 output by the radar sensor(s) 1200A, 1200B. The radar sensor data 2010 is received via the communication circuitry 2000 and can indicate a strength of the radio waves 1202A, 1202B reflected by the surface(s) of the pallet(s) 1102A, 1102B and/or the time-of-flight for the reflected radio waves 1202A, 1202B to be detected by the radars sensor(s) 1200A, 1200B. The valve state detection circuitry 2002 uses the radar sensor data 2010 to determine lift value(s) for the pallet(s) 1102A, 1102B (e.g., distance traveled, lift percentage). The valve state detection circuitry 2002 detects changes in, for example, pallet position over time that indicate the corresponding valve 1100A, 1100B moved to an open state.

In examples in which the valve state detection circuitry 2002 determines that the valve(s) 1100A, 1100B moved to an open state (block 3004), the emission calculating circuitry 2004 executes the emission measurement algorithm(s) 2016 to determine the amount (e.g., volume) of fluid emitted due to the open state of the valve(s) 1100A, 1100B (block 3006). For example, the valve state detection circuitry 2002 uses the lift value(s) (e.g., lift percentage) and flow curve data 2012 for the valve(s) 1100A, 1100B to determine the amount (e.g., volume) of fluid emitted.

At block 3006, the output control circuitry 2006 generates and outputs notification(s) 2018 with respect to the emitted fluid and/or valve state to one or more user device(s) 2020 and/or system device(s) 2022. In some examples, the output control circuitry 2006 generates and outputs device instruction(s) 2024 to cause one or more system device(s) 2022 to perform action(s) in response to the flow of fluid from the valve(s) 1100A, 1100B (e.g., cause a pump to turn on).

FIG. 4 is a block diagram of an example programmable circuitry platform 4000 structured to execute and/or instantiate the example machine-readable instructions and/or the example operations of FIG. 3 to implement the analysis circuitry 1400 of FIG. 2. The programmable circuitry platform 4000 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 4000 of the illustrated example includes programmable circuitry 4012. The programmable circuitry 4012 of the illustrated example is hardware. For example, the programmable circuitry 4012 can be implemented by one or more integrated circuits, logic circuits, FPGAs, microprocessors, CPUs, GPUs, VPUs, DSPs, and/or microcontrollers from any desired family or manufacturer. The programmable circuitry 4012 may be implemented by one or more semiconductor based (e.g., silicon based) devices. In this example, the programmable circuitry 4012 implements the example communication circuitry 2000, the example valve state detection circuitry 2002, the example emission calculating circuitry 2004, and the example output control circuitry 2006.

The programmable circuitry 4012 of the illustrated example includes a local memory 4013 (e.g., a cache, registers, etc.). The programmable circuitry 4012 of the illustrated example is in communication with main memory 4014, 4016, which includes a volatile memory 4014 and a non-volatile memory 4016, by a bus 4018. The volatile memory 4014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 4016 may be implemented by flash memory and/or any other desired type of memory device. Access to the main memory 4014, 4016 of the illustrated example is controlled by a memory controller 4017. In some examples, the memory controller 4017 may be implemented by one or more integrated circuits, logic circuits, microcontrollers from any desired family or manufacturer, or any other type of circuitry to manage the flow of data going to and from the main memory 4014, 4016.

The programmable circuitry platform 4000 of the illustrated example also includes interface circuitry 4020. The interface circuitry 4020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 4022 are connected to the interface circuitry 4020. The input device(s) 4022 permit(s) a user (e.g., a human user, a machine user, etc.) to enter data and/or commands into the programmable circuitry 4012. The input device(s) 4022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 4024 are also connected to the interface circuitry 4020 of the illustrated example. The output device(s) 4024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 4020 of the illustrated example, thus, typically includes a graphics driver card, a graphics driver chip, and/or graphics processor circuitry such as a GPU.

The interface circuitry 4020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 4026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 4000 of the illustrated example also includes one or more mass storage discs or devices 4028 to store firmware, software, and/or data. Examples of such mass storage discs or devices 4028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 4032, which may be implemented by the machine-readable instructions of FIG. 3, may be stored in the mass storage device 4028, in the volatile memory 4014, in the non-volatile memory 4016, and/or on at least one non-transitory computer-readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide for non-contact monitoring of the state of a valve using radar sensors. When the valve is in an open state, examples disclosed herein determine the amount (e.g., volume) of process fluid exiting the tank via the valve. Examples disclosed herein provide for ongoing, remote monitoring of a valve that can be used to inform of the occurrence of relief events and/or issues warranting maintenance in connection with the valve or tank. Example monitoring systems disclosed herein can be incorporated into process control systems to respond to the relief events and the discharge of fluid.

Example systems, apparatus, articles of manufacture, and methods are disclosed for pressure vacuum relief valve position monitoring with volumetric measurement are disclosed herein. Further examples and combinations thereof include the following:

Example 1 includes a system including a radar sensor to emit a radio wave; a valve, the radar sensor to detect reflection of the radio wave on a surface of the valve; machine-readable instructions; and at least one programmable circuit to execute the machine-readable instructions to determine, based on an output of the radar sensor associated with reflection of the radio wave, that the valve is in an open state; responsive to the valve being in the open state, determine an amount of fluid discharged via the valve; and output a notification indicative of the amount of discharged fluid.

Example 2 includes any preceding clause(s) of Example 1, wherein one or more of the at least one programmable circuit is to cause a pump or a blower to activate responsive to determining that the valve is in the open state.

Example 3 includes any preceding clause(s) of any one or more of Examples 1 and 2, wherein the valve includes a pallet, the pallet including the surface.

Example 4 includes any preceding clause(s) of any one or more of Examples 1–3, wherein one or more of the at least one programmable circuit is to determine a lift value associated with movement of the pallet based on the output of the radar sensor.

Example 5 includes any preceding clause(s) of any one or more of Examples 1–4, wherein the lift value is a lift percentage.

Example 6 includes any preceding clause(s) of any one or more of Examples 1–5, wherein one or more of the at least one programmable circuit is to determine a distance between the surface and a receiver of the radar sensor based on the output of the radar sensor.

Example 7 includes any preceding clause(s) of any one or more of Examples 1–6, wherein the valve is a pressure vacuum relief valve, the pressure vacuum relief valve coupled to a tank carrying the fluid.

Example 8 includes any preceding clause(s) of any one or more of Examples 1–7, wherein one or more of the at least one programmable circuit is to determine the amount of discharged fluid based on a flow curve associated with the valve.

Example 9 includes any preceding clause(s) of any one or more of Examples 1–8, wherein the valve is a first valve, the radar sensor is a first radar sensor and further including a second valve and a second radar sensor, the second radar sensor to detect reflection of a radio wave on a surface of the second valve, one or more of the at least one programmable circuit to determine, based on an output of the second radar sensor associated with reflection of the radio wave, that the second valve is in an open state; and responsive to the second valve being in the open state, determine an amount of fluid discharged via the second valve.

Example 10 includes any preceding clause(s) of any one or more of Examples 1–9, wherein the output of the radar sensor is indicative of a strength of the reflected radio wave.

Example 11 includes any preceding clause(s) of any one or more of Examples 1–10, wherein the radar sensor is a radar level transmitter.

Example 12 includes a non-transitory machine-readable storage medium comprising machine-readable instructions to cause at least one programmable circuit to at least determine, based on an output of a radar sensor, that a valve has moved from a closed state to an open state, the valve coupled to a tank; responsive to the valve moving to the open state, determine a volume of fluid emitted from the tank via the valve; and cause a notification to be output, the notification indicative of the volume of fluid.

Example 13 includes any preceding clause(s) of Example 12, wherein the machine-readable instructions are to cause one or more of the at least one programmable circuit to determine the volume of fluid based on a duration of time for which the valve is in the open state.

Example 14 includes any preceding clause(s) of any one or more of Examples 12 and 13, wherein the machine-readable instructions are to cause one or more of the at least one programmable circuit to cause a pump or a blower to activate responsive to determining that the valve is in the open state.

Example 15 includes any preceding clause(s) of any one or more of Examples 12–14, wherein the machine-readable instructions are to cause one or more of the at least one programmable circuit to determine the volume of fluid based on a flow curve associated with the valve.

Example 16 includes any preceding clause(s) of any one or more of Examples 12–15, wherein the valve is a first valve, the radar sensor is a first radar sensor, and the machine-readable instructions are to cause one or more of the at least one programmable circuit determine, based on an output of a second radar sensor, that a second valve is in an open state, the second valve coupled to the tank; and responsive to the second valve being in the open state, determine an amount of fluid emitted from the tank via the second valve.

Example 17 includes any preceding clause(s) of any one or more of Examples 12–16, wherein the notification is indicative of a total volume of fluid emitted from the tank via the first valve and the second valve.

Example 18 includes any preceding clause(s) of any one or more of Examples 12–17, wherein the output of the radar sensor is indicative of a strength of a radio wave reflected by a surface of the valve or a time-of-flight associated with detection of the reflected radio wave by the radar sensor.

Example 19 includes any preceding clause(s) of any one or more of Examples 12–18, wherein the surface is associated with a pallet of the valve and the machine-readable instructions are to cause one or more of the least one programmable circuit to determine a distance between the surface and a receiver of the radar sensor based on the output of the radar sensor.

Example 20 includes any preceding clause(s) of any one or more of Examples 12–19, wherein the machine-readable instructions are to cause one or more of the at least one programmable circuit to determine that the valve has moved from the closed state to the open state based on change in the distance over time.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
a radar sensor to emit a radio wave;
a valve, the radar sensor to detect reflection of the radio wave on a surface of the valve;
machine-readable instructions; and
at least one programmable circuit to execute the machine-readable instructions to:
determine, based on an output of the radar sensor associated with reflection of the radio wave, that the valve is in an open state;
responsive to the valve being in the open state, determine an amount of fluid discharged via the valve; and
output a notification indicative of the amount of discharged fluid.

2. The system of claim 1, wherein one or more of the at least one programmable circuit is to cause a pump or a blower to activate responsive to determining that the valve is in the open state.

3. The system of claim 1, wherein the valve includes a pallet, the pallet including the surface.

4. The system of claim 3, wherein one or more of the at least one programmable circuit is to determine a lift value associated with movement of the pallet based on the output of the radar sensor.

5. The system of claim 4, wherein the lift value is a lift percentage.

6. The system of claim 1, wherein one or more of the at least one programmable circuit is to determine a distance between the surface and a receiver of the radar sensor based on the output of the radar sensor.

7. The system of claim 1, wherein the valve is a pressure vacuum relief valve, the pressure vacuum relief valve coupled to a tank carrying the fluid.

8. The system of claim 1, wherein one or more of the at least one programmable circuit is to determine the amount of discharged fluid based on a flow curve associated with the valve.

9. The system of claim 1, wherein the valve is a first valve, the radar sensor is a first radar sensor and further including a second valve and a second radar sensor, the second radar sensor to detect reflection of a radio wave on a surface of the second valve, one or more of the at least one programmable circuit to:
determine, based on an output of the second radar sensor associated with reflection of the radio wave, that the second valve is in an open state; and
responsive to the second valve being in the open state, determine an amount of fluid discharged via the second valve.

10. The system of claim 1, wherein the output of the radar sensor is indicative of a strength of the reflected radio wave.

11. The system of claim 1, wherein the radar sensor is a radar level transmitter.

12. A non-transitory machine-readable storage medium comprising machine-readable instructions to cause at least one programmable circuit to at least:
determine, based on an output of a radar sensor, that a valve has moved from a closed state to an open state, the valve coupled to a tank;
responsive to the valve moving to the open state, determine a volume of fluid emitted from the tank via the valve; and
cause a notification to be output, the notification indicative of the volume of fluid.

13. The non-transitory machine-readable storage medium of claim 12, wherein the machine-readable instructions are to cause one or more of the at least one programmable circuit to determine the volume of fluid based on a duration of time for which the valve is in the open state.

14. The non-transitory machine-readable storage medium of claim 12, wherein the machine-readable instructions are to cause one or more of the at least one programmable circuit to cause a pump or a blower to activate responsive to determining that the valve is in the open state.

15. The non-transitory machine-readable storage medium of claim 12, wherein the machine-readable instructions are to cause one or more of the at least one programmable circuit to determine the volume of fluid based on a flow curve associated with the valve.

16. The non-transitory machine-readable storage medium of claim 12, wherein the valve is a first valve, the radar sensor is a first radar sensor, and the machine-readable instructions are to cause one or more of the at least one programmable circuit:
determine, based on an output of a second radar sensor, that a second valve is in an open state, the second valve coupled to the tank; and
responsive to the second valve being in the open state, determine an amount of fluid emitted from the tank via the second valve.

17. The non-transitory machine-readable storage medium of claim 16, wherein the notification is indicative of a total volume of fluid emitted from the tank via the first valve and the second valve.

18. The non-transitory machine-readable storage medium of claim 12, wherein the output of the radar sensor is indicative of a strength of a radio wave reflected by a surface of the valve or a time-of-flight associated with detection of the reflected radio wave by the radar sensor.

19. The non-transitory machine-readable storage medium of claim 18, wherein the surface is associated with a pallet of the valve and the machine-readable instructions are to cause one or more of the least one programmable circuit to determine a distance between the surface and a receiver of the radar sensor based on the output of the radar sensor.

20. The non-transitory machine-readable storage medium of claim 19, wherein the machine-readable instructions are to cause one or more of the at least one programmable circuit to determine that the valve has moved from the closed state to the open state based on change in the distance over time.
